(19) United States
(12) Patent Application Publication
(10) Pub. No.: US 2006/0257668 A1
(43) Pub. Date: Nov. 16, 2006

(54) Fire protection glass

(75) Inventors: Simon Frommelt, Haan (DE); Udo Gelderie, Stolberg (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SAINT-GOBAIN RECHERCHE, Aubervilliers (FR)

(21) Appl. No.: 11/493,835

(22) Filed: Jul. 27, 2006

Related U.S. Application Data
(63) Continuation of application No. 09/913,026, filed on Nov. 1, 2001, now abandoned.

(30) Foreign Application Priority Data
Feb. 25, 1999 (DE) 199 08 058.5

(51) Int. Cl. B32B 17/06; B32B 9/00

(52) U.S. Cl. 428/428; 428/426; 428/448

(57) ABSTRACT

A fire-resistant glazing assembly has at least two laminated panes between which a transparent layer made of a hydrated alkali polysilicate is placed. The hydrated alkali polysilicate contains no organic antifreeze agent. Thus, on the one hand, better resistance of the interlayer to clouding due to UV radiation and, on the other hand, greater rigidity of the interlayer compound as well as good adhesion of the panes to the interlayer in a fire are obtained.

The present invention relates to a fire-protection glazing assembly comprising at least two panes between which a transparent layer made of a hydrated alkali polysilicate is placed.

Fire-resistant glazing assemblies of this type are known from document WO 94/04355. In such known fire-resistant glazing assemblies, the SiO₂/M₂O ratio (in which M denotes the alkali metal) of the alkali polysilicate is at least 3/1 and the water content from 25 to 60% by weight. The hydrated alkali polysilicate may contain an additional hardening compound for which it is preferred to use inorganic or organic acids, esters, acid amides, glyoxal, alkylene carbonates and alkylene hydrogencarbonates, borates, phosphates and paraformaldehyde in small quantities of usually less than 5%. These additional hardeners are intended to accelerate the hardening or setting process, after application of or filling with the castable mixture, and to increase the consistency of the hardened or set layer.

These known polysilicate compositions have, in some ways, thermoplastic properties. Even when they are provided with an additional hardener, they lose internal cohesion at the temperatures which occur in the event of a fire and they start to flow. Moreover, they exhibit good adhesion, even at high temperatures, with respect to the surfaces of the silicate panes. If therefore during a fire or, depending on the case, during a fire-reaction test, that pane facing the fire breaks as a result of the tensile stresses that form in the edge region when a certain thermal gradient between the surface of the pane and the edge of the framed pane is exceeded, parts of the polysilicate composition adhering to the glass fragments are taken away with the glass fragments that fall to the ground, since the cohesive forces within the polysilicate composition are less than the adhesive forces on the surface of the glass. The protection action of the fire-resistant glazing assembly is thereby entirely impaired.

Furthermore, a fire-resistant glazing assembly is known, from EP-A-0,705,685, in which it is desired to reduce to a minimum the addition of additives, chosen from sugars or polyfunctional alcohols, to the fire-resistant interlayer essentially consisting of sodium silicate and water. These additives of the antifreeze family are presented as being indispensable. According to the abovementioned publication, the UV-sensitive interlayer becomes cloudy because of the increasing appearance of small, fine and very fine bubbles. This is why it has been proposed to partly or very largely replace this mixture with potassium silicate without, however, being able to completely dispense with the organic additives. Overall, the interlayer must contain less than 6% by weight of organic substances.

The viscosity of this interlayer may be obtained by adding particles or mixtures of particles of submicron size chosen from “inorganic Si, Al, Ti and Zr compounds” which may also be in the form of chelates.

Known fire-resistant glazing assemblies may furthermore include other panes arranged with a spacer and suitable interlayers, in which the interlayers still essentially consist, however, of sodium silicate.

The objective of the invention is to perfect a fire-resistant glazing assembly of the type mentioned in the preamble so that the panes or, depending on the case, the fragments of panes do not become detached from the polysilicate interlayer, even in the event of a fire, so that the glazing assembly remains fully effective in providing protection in a fire.

According to the invention, this objective is achieved by the fact that laminated panes are provided on each face of the hydrated fire-resistant layer and that organic additives in the interlayer are completely dispensed with.

Thus, it is also possible to completely dispense with additions of hardeners and/or chelates.

Tests have indeed shown that purely inorganic compounds, and therefore containing no glycol or similar organic substances added as antifreeze means, have considerably longer fire withstand times. In a fire, the foaming interlayer compound remains as white as snow, thereby establishing a high level of thermal reflection, and this compound flows considerably more slowly, something which has a positive effect particularly in the case of Class F 90 and F 120 products.

By substituting glycol, as antifreeze means, with inorganic salts (especially metal salts, particularly alkali metal salts, for example potassium acetate) and, where possible, completely abandoning any antifreeze means, it is possible to make the interlayer compound harder, that is to say less liable to flow, and more heat-reflective in a fire—because it is perfectly white. When an inorganic antifreeze is present, it is effective in small amounts, for example less than 5% by weight of the interlayer compound, especially less than 4%, for example about 0.5 to 3%, particularly 1 to 2%, by weight.

An assembly comprising two laminated glass panes with an interlayer of 1.5 to 12 mm in thickness made from a purely inorganic filling compound of potassium silicate is particularly advantageous.

It should be pointed out that the purely inorganic interlayer according to the invention could, admittedly theoretically, be also combined with monolithic glass sheets but that glass splinters could then become detached in a fire.

In one particularly appropriate embodiment of the invention, the panes of laminated glass consist of two sheets of float glass each having a thickness of at least 1 mm and advantageously from 1 to 4 mm, particularly each having a thickness of at least 2 mm. They are connected together by a thermoplastic film of polyvinyl butyral (PVB), of tetrafluoroethylene/hexafluoropropylene/vinylidene fluoride (THV) or of ethylene/vinyl acetate (EVA). In this embodiment, the high tensile stresses caused by the thermal gradients occur during the fire-reaction test on the side exposed to the fire in the sheet of float glass of the laminated pane facing the fire so that this sheet breaks. The stresses which occur in this glass sheet are not transferred to the other glass sheet of the laminated pane since they are taken up by the thermoplastic film interlayer, which softens. On the other hand, the other sheet of float glass connected to the polysilicate composition does not generally break, for the above reason. In all cases the other sheet of glass remains, even when it breaks, during the continuation of the fire-reaction test, connected to the polysilicate composition and, in this way, helps to fulfil the fire protection function.

Of course, the construction of the laminated panes is not limited to the preferred embodiments; it is possible to employ, in particular, laminates consisting of more than two rigid sheets with corresponding interlayers. It is also possible to vary the thickness of the individual glass sheets as required.

The alkali polysilicate composition according to the invention may be cast between panes as a relatively thick layer, for example having a thickness of 4 to 12 mm, the panes being held a certain distance around the edge by spacer frames of corresponding thickness. However, it is also quite possible to apply the polysilicate composition to laminated panes as thin layers approximately 0.5 to 5 mm, especially 1 to 2 mm, in thickness and to join together several panes of a multilayer fire-resistant glass which are coated in this way. According to this embodiment, the laminated panes may each have a thickness of at least 2.5 to 10 mm in thickness. Advantageously, the fire-resistant glazing assembly comprises at least three laminated panes between which thin alkali polysilicate layers are placed. The laminated panes are generally not toughened (tempered) but may, depending on the requirements, contain one or two sheets of toughened glass. Since the polysilicate layers are relatively hard, fire-resistant glass of this type may consequently be manufactured in large units and, depending on the requirements, be sawn into units of smaller size, such as a normal laminated glazing assembly.

Compared with conventional fire protection glazing assemblies composed of monolithic glass sheets, the acoustic insulation is also improved by using two laminated panes.

A fire-resistant glass according to the prior art (comparative example) and two illustrative examples of fire-resistant glasses according to the invention will be described in more detail below.

### COMPARATIVE EXAMPLE

A fire-resistant glass with dimensions of 200 cm×120 cm is manufactured from two panes of laminated glass and a hydrated alkali polysilicate interlayer 6 mm in thickness placed between these panes of laminated glass. The panes of laminated glass each consist of two sheets of float glass, each 2 mm in thickness, which are joined together by a self-crosslinking film of EVA 0.3 mm in thickness. The two panes of laminated glass are joined together as a double glazing unit by inserting a spacer frame made from a profile strip of silicone rubber and are sealed around the edge with an adhesive sealing composition, for example a polysulphide adhesive composition, a filling orifice and an air purging hole being provided for filling the double glazing unit.

The internal cavity of the double glazing unit is filled with a castable composition consisting of an aqueous solution of potassium silicate and an aqueous dispersion of colloidal silica. The SiO₂/K₂O ratio of the castable composition is 4.7/1. The composition contains glycol in an amount of approximately 4.5% by weight of this mass. The cast composition is left to set at a temperature of 80° C.

In order to determine the degree of crosslinking of the set composition, the rate of penetration of a 10 mm diameter steel ball loaded with a weight of 1 kg into a specimen prepared from the same casting composition and set under the same conditions is measured, during which the distance that the ball has penetrated into the composition over a time interval of 10 minutes is measured. For this polysilicate composition, the penetration depth is 9 mm.

The fire withstand tests are carried out according to the DIN 4102 or, depending on the case, the ISO/DIS 834-1 standard on the fire-resistant glasses, according to the so-called standard temperature curve. Three minutes after the start of the fire withstand test, the outer sheet of float glass of the laminated pane facing towards the body of the fire shatters. Six minutes after the start of the fire withstand test, the sheet of float glass of this laminated pane which adheres to the polysilicate composition shatters. Shortly afterwards, the first glass fragments of the broken sheet of float glass become detached and drop into the body of the fire. The conditions for fire-resistance class F 30 are not fulfilled.

### ILLUSTRATIVE EXAMPLE 1

Fire-resistant glasses are manufactured as described in the comparative example, with the difference that no glycol, as antifreeze agent, was added to the castable mixture of aqueous potassium silicate and an aqueous dispersion of colloidal silicic acid having the same SiO₂/K₂O ratio as in the comparative example. As in the case of the comparative example, the setting of the casting composition was carried out at 80° C.

The degree of crosslinking is determined using the method described in the comparative example on a specimen prepared from the same casting composition and set under the same conditions. The measurement gives a depth of penetration by the weight-loaded ball of 3 mm, that is to say the internal solidity or the crosslinking of the set polysilicate is approximately three times that for the polysilicate of the comparative example.

During a fire withstand test carried out on these fire-resistant glasses, the outer sheet of float glass of the laminated pane which faces the body of the fire also shatters after a few minutes. Shortly afterwards, the sheet of float glass of this laminated pane which adheres to the polysilicate composition also shatters. However, the fragments of this glass sheet do not drop, but remain adhered to the polysilicate layer and form a rigid unit with the latter. The polysilicate compound, which is converted into a foam, remains here perfectly white. The weight of the glass sheet which still adheres to it is not sufficient to cause the now harder compound to flow.

The fire withstand test is interrupted after 45 minutes and, immediately after extinguishing the burners, the “extinguishing water test” is carried out, in which a powerful jet of water is directed from the outside onto the fire-resistant glass. The laminated pane facing towards the fire is, partially broken, however the glass holds together because of the still intact film. The sheet of glass facing the fire still adheres to the mass of polysilicate.

The adhering glass fragments have protected the polysilicate layer from the onslaught by the water jet. The perfectly white sheet of polysilicate stiffened and protected by the adherent glass fragments on both sides, as previously, is not destroyed by the water jet so that this fire-resistant glazing assembly according to the invention, on the one hand, fulfils the conditions of fire-resistance class F 30 and, on the other hand, also withstands the “extinguishing water test”.

### ILLUSTRATIVE EXAMPLE 2

Again, fire-resistant glasses of the type described in the comparative example are manufactured with, however, the difference that, as alkali silicate, a mixture containing 85% by weight potassium silicate and 15% by weight lithium silicate is used, which, mixture is made to react in water with a dispersion of 30% silicic acid in a proportion such that the K—Li polysilicate which results has a SiO₂/(K₂O+Li₂O) molar ratio of 5.0/1. Added to this casting composition are 2% by weight of potassium acetate as inorganic antifreeze. Next, the compound is converted into a fire-resistant glass as in the comparative example. However, the thickness of the interlayer rises to 12 mm. The setting of the composition takes place, as in the case of the comparative example, at 80° C. After the setting, a 200 cm×120 cm furnace test piece is cut from the plate thus obtained, the edge of the test piece being sealed with a polysulphide.

Measurements of the rate of penetration by a weight-loaded ball into a specimen of this polysilicate according to the process described in the comparative example show a depth of penetration of 5 mm. The setting or, depending on the case, the degree of crosslinking of this polysilicate is thus greater by approximately a factor of 2 than the specimen of the comparative example.

The fire withstand tests carried out on these fire-resistant glasses and the “extinguishing water test” show no kind of flow of the interlayer compound into the body of the fire, even after an exposure time of more than 60 minutes; that is to say these fire-resistant glasses also fulfil the conditions of fire-resistance class F 60 and also withstand the “extinguishing water test”.

1-7. (canceled)

8. A fire-resistant glazing assembly, comprising:
at least two outer panes between which a transparent layer comprising a hydrated alkali polysilicate and an inorganic antifreeze is present,
wherein each outer pane is a laminated pane comprising at least two glass sheets and a thermoplastic film interlayer between the two sheets, and wherein the alkali polysilicate layer comprises no organic antifreeze.

9. The fire-resistant glazing assembly of claim 8, wherein the alkali polysilicate layer has a thickness of 1.5 to 12 mm.

10. The fire-resistant glazing of claim 8, wherein the laminated panes comprise two sheets of float glass having a thickness of from 1 to 4 mm and an interlayer comprising at least one of polyvinyl butyral, tetrafluoroethylene/hexafluoropropylene/vinylidene fluoride or ethylene/vinyl acetate between the panes.

11. The fire-resistant glazing assembly of claim 8, comprising at least three laminated panes, each pane having a thickness of from 2.5 to 10 mm.

12. The fire-resistant glazing assembly of claim 8, wherein each pane is separated from the adjacent plane by a layer of hydrated alkali polysilicate having a thickness of from 0.5 to 5 mm.

13. The fire-resistant glazing assembly of claim 8, wherein the inorganic antifreeze is present in an amount of less than 5 weight percent of the alkali polysilicate layer.

14. The fire-resistant glazing assembly of claim 8, wherein the inorganic antifreeze is an alkali metal salt.

15. The fire-resistant glazing assembly of claim 8, wherein the inorganic antifreeze is potassium acetate.

16. The fire-resistant glazing assembly of claim 8, wherein the layer comprising the hydrated alkali polysilicate is obtained by casting a composition consisting of an aqueous solution of potassium silicate and an aqueous dispersion of colloidal silica.

17. The fire-resistant glazing assembly of claim 8, wherein the hydrated alkali polysilicate has an SiO₂/K₂O ratio of 4.7/1.

18. The fire-resistant glazing assembly of claim 8, wherein the hydrated alkali polysilicate is a crosslinked mixture containing potassium silicate, lithium silicate and silicic acid.

19. The fire-resistant glazing assembly of claim 8, wherein each pane is a laminated pane.

20. The fire-resistant glazing assembly of claim 8, wherein the glazing has an F60 fire resistance classification.

21. The fire-resistant glazing assembly of claim 8, wherein the thermoplastic film interlayer is polyvinyl butyral.

22. The fire-resistant glazing assembly of claim 8, wherein the thermoplastic film interlayer is tetrafluoroethylene/hexafluoropropylene/vinylidene fluoride.

23. The fire-resistant glazing assembly of claim 8, wherein the thermoplastic film interlayer is ethylene/vinyl acetate.

24. The fire-resistant glazing assembly of claim 8, comprising no hardeners or chelates.

25. The fire-resistant glazing assembly of claim 16, wherein the potassium acetate is present in an amount of from 1 to 2% by weight.
